(19) United States
(12) Patent Application Publication
(10) Pub. No.: US 2026/0356756 A1
(43) Pub. Date: Nov. 12, 2026

(54) STABLE AMINE-BASED DEFOAMER FOR ADMIXTURE ADDITIVES

(71) Applicant: KAO CORPORATION, Tokyo (JP)

(72) Inventors: Samuel John THOMPSON, High Point, NC (US); Andrew HUGHES, High Point, NC (US); Mohand MELBOUCI, High Point, NC (US)

(73) Assignee: KAO CORPORATION, Tokyo (JP)

(21) Appl. No.: 19/108,810

(22) PCT Filed: Sep. 6, 2023
(86) PCT No.: PCT/US2023/032113

§ 371 Date: Mar. 5, 2025

Related U.S. Application Data
(60) Provisional application No. 63/374,839, filed on Sep. 7, 2022.

(51) Int. Cl. C04B 24/32; C04B 28/02; C04B 40/00; C04B 103/50

(52) U.S. Cl. CPC C04B 24/32; C04B 28/02; C04B 40/0039; C04B 2103/50

(57) ABSTRACT

A defoamer for reduction of air entrainment in cement compositions. The defoamer is a polyalkoxylated alkyl polyamine having the structure of Formula (1) or (2), and salts thereof, R¹—(N(R²)—CH₂—CH₂—CH₂)ₙ—N—(R³)(R⁴) (1), R¹—N(CH₂—CH₂—CH₂—N(R³)(R⁴))₂ (2), where R¹ is a branched or unbranched hydrocarbon chain of 1 to 20 carbons in length, R², R³, and R⁴ each independently represent at least one or more of H, an alkylene oxide, or a polyalkylene oxide, and n is 1 to 50. The defoamer may be used with a superplasticizer in an admixture for a cement composition. The defoamer provides increased stability and solubility of the admixture under thermal aging.

### CROSS-REFERENCE TO RELATED APPLICATIONS

The present application is based on and claims the benefit of priority to U.S. Application No. 63/374,839, filed Sep. 7, 2022. The contents of this application are incorporated herein by reference in their entirety.

### BACKGROUND OF THE INVENTION

### Technical Field

The present invention relates to an alkoxylated alkyl polyamine defoaming agent for controlling air-entrainment in cementitious compositions.

### Description of the Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly nor impliedly admitted as prior art against the present invention.

The preparation of concrete requires mixing several components such as hydratable cement, sand, gravel, water, and additives to form a homogeneous mixture. One frequently employed additive is a superplasticizer, which is incorporated into the mixture to reduce the required water content, optimize the initial flow, and slump retention over time and improve mechanical properties, such as compressive strength. A controlled air-entrainment additive is also desired to impart expanded freeze-thaw stability of the set concrete. Superplasticizers often have structures of comb-like copolymers, with one monomer comprised of carboxylate end groups and another monomer comprised of ethylene oxide repeating units attached to the polymeric chain. Specifically, comb-like copolymers derived from acrylic acid monomers are well known superplasticizers.

One undesirable side-effect of superplasticizers is the introduction of excess air into the finished concrete. This entrainment of air can be beneficial to enhance the freeze-thaw stability of the concrete, however, proper control of the air entrained is necessary to prevent undesired negative impact on the physical properties (compressive strength) of the set concrete. The standard approach to reduce such a negative impact, is to use defoaming agents to minimize the air-entrainment. Those defoamers are generally hydrophobic materials, such as nonionic surfactants with a low HLB, silicone derivatives, di- and tri-butylphosphates, and alkyl phthalates.

Due to the hydrophobic nature of the defoamers they are poorly water soluble and are unable to be incorporated into aqueous admixture solutions with a long-term stability. Attempts to compatibilize the defoamers in miscible polymers or through dispersion in the admixture (especially, superplasticizers) solution do not provide extended stability. The blended mixtures typically phase separate quickly, which requires the aqueous superplasticizer solution and defoamer to be stored separately and only mixed immediately prior to use to ensure good control of the air-entrainment. Alternatively, the defoamer can be added to a constantly stirred superplasticizer solution to prevent separation, sometimes with stabilizing surfactants. See U.S. Pat. No. 6,139,623-incorporated herein by reference in its entirety. The defoamer incompatibility in aqueous superplasticizer solutions presents an obvious drawback to the user through added costs, facility space, and use limitations.

Prior art to overcome the hydrophobic incompatibility issues of defoamers has been established. Incorporation of amine units to the defoamer structure can impart ionic paring with carboxylic acid functionalities of the superplasticizer polymer structure. Kuo in U.S. Pat. No. 8,187,376 disclosed polyalkoxylated polyalkylene polyamines as defoaming agents.

Like conventional defoamers, amine defoamers used to solve air entrainment problems can only be formulated at relatively low concentrations in the superplasticizer solutions. At higher concentrations performance is reduced, and the admixture formulations typically become unstable after a short period of time. In particular, exposure of these solutions to elevated temperatures results in separation of the defoamer from the aqueous superplasticizer solution. Thus, there still exists a need for a single, storage-stable cement admixture that can be used at low and high concentrations and maintain stability across a wide range of environmental conditions. In view of the foregoing, one objective of the present invention is to provide a defoamer with improved stability and use of the defoamer in an admixture with a superplasticizer for cement compositions.

### BRIEF SUMMARY OF THE INVENTION

The present invention provides:

(1) A defoamer for reduction of air entrainment, comprising a polyalkoxylated alkyl polyamine having a structure represented by the following formulas (1) or (2) and salts thereof

R¹—(N(R²)—CH₂—CH₂—CH₂)ₙ—N—(R³)(R⁴) (1),

R¹—N(CH₂—CH₂—CH₂—N(R³)(R⁴))₂ (2),
where R¹ is a branched or unbranched hydrocarbon chain of 1 to 20 carbons in length, R², R³, and R⁴ each independently represent H, an alkylene oxide, or a polyalkylene oxide, and n is 1 to 50.

(2) A defoamer for reduction of air entrainment, comprising a polyalkoxylated alkyl diamine having a structure represented by Formula (3) and salts thereof

R¹—N(R²)—CH₂—CH₂—CH₂—N—(R³)₂ (3),
where R¹ is a branched or unbranched hydrocarbon chain of 1 to 20 carbons in length, and R² and R³ each independently represent H, an alkylene oxide, or a polyalkylene oxide.

(3) The defoamer of (1) or (2), where the alkylene oxide is propylene oxide or ethylene oxide.

(4) The defoamer of any one of (1) to (3), where the polyalkylene oxide comprises repeating groups of propylene oxide and/or ethylene oxide.

(5) The defoamer of any one of (1) to (4), where R¹ is a branched or unbranched hydrocarbon chain of 12 to 18 carbons in length.

(6) The defoamer of any one of (1) to (5), wherein a combined weight percentage of propylene oxide and polypropylene oxide is in a range of 45 to 75 wt %, relative to the polyalkoxylated alkyl polyamine.

(7) The defoamer of any one of (1) to (6), wherein R¹ is tallow-alkyl.

(8) An admixture, comprising the defoamer of any one of (1) to (7) and an alkali aqueous solution, suspension, or slurry.

(9) An admixture for reduction of air entrainment, comprising: a dispersant, the defoamer of any one of (1) to (7), and water. The dispersant and the defoamer are present at a combined concentration in a range of 25 to 35 wt % relative to the total weight of the admixture, and the defoamer is present at a concentration of 0.1 to 20 wt % relative to the weight of the dispersant.

(10) The admixture of (9), where the defoamer is present at a concentration of 4 to 15 wt % relative to a total weight of the dispersant.

(11) The admixture of (9) or (10), which has a pH in a range of 4.5 to 6.5.

(12) The admixture of any one of (9) to (11), where the dispersant is a superplasticizer selected from the group consisting of a polycarboxylate ether, a sulfo-modified melamine-formaldehyde condensate, a melamine formaldehyde condensate, a sulfonated melamine-formaldehyde condensate, a lignin salt, a naphthalene sulfonate, a polycarboxylated acrylic, a polycarboxylated ether, a carboxylic acid salt, casein, a cocomide derivative, and mixtures thereof.

(13) The admixture of any one of (9) to (12) where the dispersant is at least one selected from the group consisting of a polycarboxylate ether, an ester-type dispersant, an ether-type dispersant, and a naphthalene type dispersant.

(14) The admixture of any one of (9) to (13) where the dispersant is a polycarboxylate ether comprising pendant polyethylene oxide groups.

(15) The admixture, comprising:
a dispersant;
the defoamer of any one of (1) to (7); and
water,
wherein the dispersant and the defoamer are present at a combined concentration in a range of 25 to 35 wt % relative to the total weight of the admixture, and
wherein the defoamer is present at a concentration of 0.1 to 20 wt % relative to the weight of the dispersant,
wherein the dispersant is a polycarboxylate ether copolymer, including constituent unit (4) represented by the following formula (4) and constituent unit (5) represented by the following formula (5),

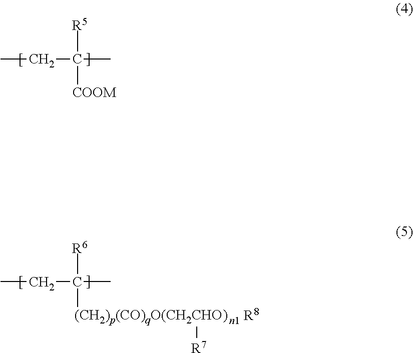

wherein unit (4) is methacrylic acid and its salt,
wherein unit (5) is methoxy polyethylene glycol monomethacrylate,
wherein n1 is an average number of added moles, and represents a number of 15 or more and 30 or less,
wherein a proportion of constituent unit (4) in a total of contents of constituent units (4) to (5) is 65 mol % or more and 80 mol % or less, and
wherein a weight average molecular weight (Mw) of the polycarboxylate ether copolymer is 35,000 or more, and 60,000 or less.

(16) The admixture, comprising:
a dispersant;
the defoamer of any one of (1) to (7); and
water,
wherein the dispersant and the defoamer are present at a combined concentration in a range of 25 to 35 wt % relative to the total weight of the admixture,
wherein the defoamer is present at a concentration of 0.1 to 20 wt % relative to the weight of the dispersant,
wherein the dispersant is a polycarboxylate ether copolymer, including constituent unit (4′) represented by the following formula (4′) and constituent unit (5′) represented by the following formula (5′),

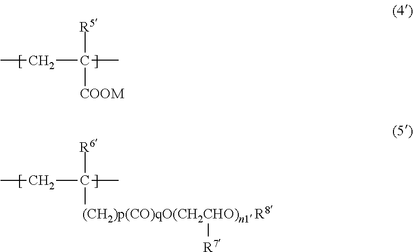

wherein unit (4′) is methacrylic acid and its salt,
wherein unit (5′) is methoxy polyethylene glycol monomethacrylate,
wherein n1′ is an average number of added moles, and represents a number of 80 or more and 120 or less,
wherein a proportion of constituent unit (4′) in a total of contents of constituent units (4′) to (5′) is 70 mol % or more and 90 mol % or less, and
wherein a weight average molecular weight (Mw) of the polycarboxylate ether copolymer is 35,000 or more, and 60,000 or less.

(17) A cement mixture, comprising a particulate cementitious component, the admixture of any one of (9) to (16), and water, where the admixture is present in the cement mixture at a concentration in a range of 0.05 to 1 wt % by weight of cement.

(18) The cement mixture of (17), where the admixture is present in the cement mixture at a concentration in a range of 0.1 to 0.5 wt % by weight of cement.

(19) The cement mixture of (17) or (18), which has a W/C ratio of 0.37 to 0.50.

(20) The cement mixture, comprising:
a particulate cementitious component;
an admixture of any one of (9) to (16); and
water,
wherein a solid content of the admixture is present in the cement mixture at a concentration in a range of 0.05 to 1 wt % by weight of cement, and
wherein a W/C ratio is in a range of 0.37 to 0.50.

(21) The cement mixture of any one of (17) to (20), further comprising 45-60 wt % sand relative to a total weight of the cement mixture.

(22) A method of forming an admixture, the method comprising mixing an alkali aqueous solution, suspension, or slurry, and the defoamer of any one of (1) to (7).

(23) A method of forming a cement mixture, the method comprising mixing a particulate cementitious component, the admixture of any one of (9) to (16), and water. The admixture is present in the cement mixture at a concentration in a range of 0.05 to 1 wt % by weight of cement.

(24) The method of forming a cement mixture, the method comprising:
mixing a particulate cementitious component,
the admixture of any one of (9) to (16), and
water,
wherein the admixture is present in the cement mixture at a concentration in a range of 0.05 to 1 wt % by weight of cement, and
wherein a W/C ratio is in a range of 0.37 to 0.50.

(25)

A method for reducing air voids in a cement mixture, the method comprising: mixing the defoamer of any one of (1) to (7) and a dispersant with a cement mixture.

(26) Use for a deformer of a composition comprising a polyalkoxylated alkyl polyamine having a structure represented by Formula (1) or (2), and salts thereof

R¹—(N(R²)—CH₂—CH₂—CH₂)ₙ—N—(R³)(R⁴) (1),

R¹—N(CH₂—CH₂—CH₂—N(R³)(R⁴))₂ (2),
where R¹ is a branched or unbranched hydrocarbon chain of 1 to 20 carbons in length, R², R³, and R⁴ each independently represent H, an alkylene oxide, or a polyalkylene oxide, and n is 1 to 50.

(27) Use for a deformer of Embodiment (23) for an alkali aqueous solution, suspension, or slurry.

(28) Use for a deformer of Embodiment (23) for a hydraulic composition.

The foregoing paragraphs have been provided by way of general introduction and are not intended to limit the scope of the following claims. The described embodiments, together with further advantages, will be best understood by reference to the following detailed description taken in conjunction with the accompanying drawings.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1A shows the control superplasticizer M-1 with no defoamer

FIG. 1B shows M-1 superplasticizer as-is and pre-blended with ester defoamer (0.50 wt % defoamer loading/active PCE) after 1 week of thermal aging at 50 °C.

FIG. 2 shows the long-term stability of various Defoamer S2 loadings (0.5 to 12.0% per active PCE) in M-2 superplasticizer after thermal aging.

FIG. 3 is a graph showing the air void reduction of cement mortar mix at various defoamer loadings.

### DETAILED DESCRIPTION OF THE EMBODIMENTS

Embodiments of the present disclosure will now be described more fully hereinafter with reference to the accompanying drawings, in which some, but not all embodiments of the disclosure are shown.

The present disclosure will be better understood with reference to the following definitions. As used herein, the words “a” and “an” and the like carry the meaning of “one or more.” Within the description of this disclosure, where a numerical limit or range is stated, the endpoints are included unless stated otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the words “about,” “approximately,” or “substantially similar” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), +/−15% of the stated value (or range of values), or +/−20% of the stated value (or range of values). Within the description of this disclosure, where a numerical limit or range is stated, the endpoints are included unless stated otherwise. Also, all values and subranges within a numerical limit or range are specifically included as if explicitly written out.

As used herein, “compound” is intended to refer to a chemical entity, whether as a solid, liquid, or gas, and whether in a crude mixture or isolated and purified.

As used herein, “composite” refers to a combination of two or more distinct constituent materials into one. The individual components, on an atomic level, remain separate and distinct within the finished structure. The materials may have different physical or chemical properties, that when combined, produce a material with characteristics different from the original components. In some embodiments, a composite may have at least two constituent materials that comprise the same empirical formula but are distinguished by different densities, crystal phases, or a lack of a crystal phase (i.e. an amorphous phase).

The present disclosure is intended to include all hydration states of a given compound or formula, unless otherwise noted or when heating a material. In addition, the present disclosure is intended to include all isotopes of atoms occurring in the present compounds and complexes. Isotopes include those atoms having the same atomic number but different mass numbers. By way of general example, and without limitation, isotopes of hydrogen include deuterium and tritium. Isotopes of carbon include ¹³C and ¹⁴C. Isotopes of nitrogen include ¹⁴N and ¹⁵N. Isotopes of oxygen include ¹⁶O, ¹⁷O, and ¹⁸O. Isotopically-labeled compounds of the disclosure may generally be prepared by conventional techniques known to those skilled in the art or by processes analogous to those described herein, using an appropriate isotopically-labeled reagent in place of the non-labeled reagent otherwise employed.

References to compounds in their salt form may be understood to include reference to their acid form, and vice-versa, because it may be the case that both acid and salt forms can co-exist within the aqueous environment. Similarly, it may also be understood that reference to compounds in their amine form may be understood to include reference to their ammonium form, and vice-versa.

The term “cementitious” as used herein refers to materials that include or comprise cement (e.g., Portland cement) or which otherwise function as a binder to hold together fine aggregates (e.g., sand), coarse aggregates (e.g., crushed gravel), or mixtures thereof. A cementitious component may be particulate. The term “cement” as used herein includes hydratable cement which is produced by pulverizing clinker consisting of hydraulic calcium silicates and one or more forms of calcium sulfate (e.g., gypsum) as an interground additive. Any type of cement or cement containing material may be used in any of the embodiments disclosed herein. For example, cement may include type I, type Ia, type II, type IIa, type III, type IIIa, type IV and type V Portland cements (using either the ASTM C150 standard or the European EN-197 standard), hydraulic cements, non-hydraulic cements, Portland flyash cement, Portland Pozzolan cement, Portland silica fume cement, masonry Cements, mortars, EMC cements, stuccos, plastic cements, expansive cements, white blended cements, Pozzolan-lime cements, slag-lime cements, supersulfated cements, calcium aluminate cements, calcium sulfoaluminate cements, geopolymer cements, Rosendale cements, polymer cement mortar, lime mortar, and/or Pozzolana mortar. The term “mortar” refers to cement compositions which include one or more fine aggregates such as sand or other fine particulate materials. In one embodiment SiO₂ may be present in cement.

Cement may include SiO₂-containing materials including but not limited to belite (2CaO·SiO₂), alite (3CaO·SiO₂), celite (3CaO·Al₂O₃), or brownmillerite (4CaO·Al₂O₃·Fe₂O₃) commonly found in sand-free cement.

“Mortars” are cement pastes formed with water and additionally including fine aggregate (e.g., sand), while “concretes” are mortars which additionally include coarse aggregate (e.g., crushed stones or gravel).

Typically, Portland cement is combined with one or more other supplementary cementitious materials (“SCMs”) and provided as a blend. SCMs may include limestone, hydrated lime, fly ash, granulated blast furnace slag, and silica fume, or other materials commonly included in such cements. Cementitious materials may therefore include one or more SCMs preferably in an amount of 0%-100%, more preferably 10%-60%, based on total dry weight of cementitious material.

The term “hydratable” as used herein is intended to refer to cement or cementitious materials that are hardened by chemical interaction with water. Portland cement clinker is a partially fused mass primarily composed of hydratable calcium silicates. The calcium silicates are essentially a mixture of tricalcium silicate (3CaO·SiO₂ “C₃S” in cement chemists notation) and dicalcium silicate (2CaO·SiO₂, “C₂S”) in which the former is the dominant form, with lesser amounts of tricalcium aluminate (3CaO·Al₂O₃, “C₃A”) and tetracalcium aluminoferrite (4CaO·Al₂O₃·Fe₂O₃, “C₄AF”). See e.g., Dodson, Vance H., Concrete Admixtures (Van Nostrand Reinhold, New York N.Y. 1990), page 1—incorporated by reference in its entirety.

The term “additive” shall be used herein to describe additives added at the cement manufacturing plant and also to describe “admixtures” which are added to cement, water, and optional aggregates used for making cement mortars, concretes, and other cementitious materials. Preferably, the additive compositions are aqueous liquids that may be dispensed in liquid form.

According to a first aspect, the present disclosure provides a defoamer for reduction of air entrainment, which refers to air or any gas or any collection of gases incorporated within a mixture. In reducing air entrainment, the defoamer, when added to a mixture, facilitates the release of air from the mixture. The defoamer comprises a polyalkoxylated alkyl polyamine having a structure represented by Formula (1) or Formula (2) and salts thereof:

R¹—(N(R²)—CH₂—CH₂—CH₂)ₙ—N—(R³)(R⁴) (1),

R¹—N(CH₂—CH₂—CH₂—N(R³)(R⁴))₂ (2),
Wherein, From the viewpoint of defoamability, R¹ is a branched or unbranched hydrocarbon chain of preferably 1 to 20, 5 to 20, 10 to 20, 12 to 18, or 14 to 18 carbons in length. In one embodiment, R¹ is more preferably tallow-alkyl. From the viewpoint of solubility in water and defoamability, R² and R³ each independently represent at least one or more of H, an alkylene oxide, or a polyalkylene oxide, and n is preferably 1 to 50, 2 to 45, 3 to 40, 4 to 35, 5 to 30, 6 to 25, 7 to 20, or 8 to 15.

In another embodiment, the defoamer comprises a polyalkoxylated alkyl diamine having a structure represented by Formula (3) and salts thereof

R¹—N(R²)—CH₂—CH₂—CH₂—N—(R³)₂ (3),
wherein, from the viewpoint of defoamability, R¹ is a branched or unbranched hydrocarbon chain of preferably 1 to 20, 5 to 20, 10 to 20, 12 to 18, or 14 to 18 carbons in length. In one embodiment, R¹ is more preferably tallow-alkyl, and R² and R³ each independently represent H, an alkylene oxide, or a polyalkylene oxide.

In one embodiment, the alkylene oxide is propylene oxide and/or ethylene oxide. In one embodiment, the alkylene oxide is propylene oxide, and the polyalkylene oxide is polypropylene oxide. In one embodiment, the polyalkylene oxide comprises repeating groups of propylene oxide and/or ethylene oxide. Here, from the viewpoint of solubility in water and defoamability, an individual polyalkylene oxide chain may comprise on average 1-15 groups of propylene oxide and/or ethylene oxide, or preferably 1 to 12, 1 to 10, 2 to 8, 2 to 7, or 3 to 5 groups on average. In one embodiment, where both propylene oxide and ethylene oxide are present in the alkylene oxide and/or the polyalkylene oxide, from the viewpoint of defoamability, a weight percentage of the propylene oxide relative to the combined weight of the propylene oxide and the ethylene oxide is preferably 50 wt % or more, 60 wt % or more, 70 wt % or more, 80 wt % or more, 90 wt % or more, 95 wt % or more, or 100 wt %.

In one embodiment, where the alkylene oxide is propylene oxide, and the polyalkylene oxide is polypropylene oxide, from the viewpoint of defoamability, a combined weight percentage of propylene oxide and polypropylene oxide is in a range of 45 to 75 wt %, preferably 50 to 70 wt %, more preferably 60 to 70 wt %, relative to the polyalkoxylated alkyl polyamine.

In one embodiment, from the viewpoint of defoamability and water solubility, a weight percentage of propylene oxide is preferably in a range of 45 to 75 wt %, 50 to 70 wt %, or 55 to 65 wt % relative to a combined mass of the polyalkoxylated alkyl polyamine and the propylene oxide.

In one embodiment, from the viewpoint of defoamability and economic efficiency, the defoamer is preferably produced by reacting N-(tallowalkyl)dipropylene triamine with propylene oxide, wherein a weight percentage of propylene oxide is in a range of 45 to 75 wt %, 50 to 70 wt %, or 55 to 65 wt % relative to a combined mass of the N-(tallowalkyl)dipropylene triamine and the propylene oxide.

In one embodiment, from the viewpoint of defoamability, the defoamer has preferably a number average molecular weight or weight average molecular weight in a range of 350 to 5,000 g/mol, 400 to 4,000 g/mol, 500 to 2,000 g/mol, 600 to 1,000 g/mol, or 700 to 800 g/mol.

The average molecular weight was determined from the quantified total amine value of the inventive defoamers. The total amine value is obtained from neutralizing the amines present in the defoamer with a known acid and converting the amount of acid to units of potassium hydroxide. The measurement was conducted in accordance with ASTM D 2073.

In other embodiments the defoamer is not produced from a tallow alkylamine but from an alkylamine derived from coconut oil, soybean oil, palm kernel oil, or mixtures thereof.

In other embodiments the defoamer may be used in a wide range of applications, starting with any aqueous mixture for which it is desirable to control the specific air content of the mixture, and especially in mixtures containing amphiphilic molecules. Non-limiting examples of such applications include, but are not limited to construction materials, coatings and adhesives, particularly pressure sensitive adhesives.

Specific examples of construction materials include self-leveling mortars, cement, grouts, overlayerments, and screeds. The invention may be used in other construction material such as heat insulating wall mortar tiles, autocatalytic mortar tiles, self-consolidating concrete compositions, wet plasters, rendering compositions, offshore cementitious compositions, oilfield cementitious compositions, and pigment slurries. The invention is useful in production of cement products including as a grind-aid. In particular, the invention is useful in preparing admixtures. Such admixtures include, but are not limited to, high range water reduction admixtures, superplasticizing admixtures, retarding admixtures, sprayed concrete admixtures, foamed concrete admixtures, and strength enriching admixtures. Specific examples of coatings in which the present invention can be used include overprint varnishes, plastic coatings, and clearcoats. Additional non-limiting examples of applications for the de-airentrainer composition of the present invention include ink formulations and manufacture, inkjet ink formulations and manufacture, metal working fluids, and industrial and institutional cleaning compositions.

Without being bound to theory, it is believed that the amine units present in the inventive defoamer structure are ionized by acidic species present in superplasticizers and thereby solubilized to afford stable, homogeneous mixtures. The degree of propylene oxide incorporation achieves a solubility of the defoamer in low pH formulations that is not observed with other similar structures. Addition of the defoamer to cement, which has a high pH, neutralizes the inventive defoamer to a more hydrophobic species that imparts lipid bilayer disruption. The defoamer has a surfactant structure with a relatively hydrophilic head group at the propylene oxide end of the molecule while the branched or unbranched hydrophobic hydrocarbon chain (R¹) is highly hydrophobic and is hypothesized to transport into the foam lamellae, thus destabilizing and dewetting the foam lamellae resulting in suppression of foam in the application.

According to a second aspect, the present disclosure provides an admixture for reduction of air entrainment, for instance, in a mortar or cement composition.

In one embodiment, the admixture comprises the defoamer of the first aspect of the disclosure, and an alkali aqueous solution, an alkali aqueous suspension, or an alkali aqueous slurry. Examples of the alkali aqueous solution, suspension, or slurry include, but are not limited to, combustion ash suspensions, hydraulic compositions, and cement compositions, preferably cement compositions.

In one embodiment, the admixture comprises a dispersant, the defoamer of the first aspect of the disclosure, and water. From the viewpoint of defoamability and storage stability, the dispersant and the defoamer may be present preferably at a combined concentration in a range of 25 to 35 wt %, 27 to 33 wt %, 29 to 31 wt %, or about 30 wt % relative to the total weight of the admixture. From the viewpoint of defoamability and storage stability, the defoamer is present preferably at a concentration of 0.1 to 20 wt %, 0.2 to 18 wt %, 0.4 to 16 wt %, 0.5 to 15 wt %, 0.7 to 13 wt %, 1 to 12 wt %, 3 to 10 wt %, 4 to 9 wt %, or 5 to 8 wt % relative to the weight of the dispersant.

In one embodiment, from the viewpoint of storage stability, the admixture has preferably a pH in a range of 4.5 to 6.5, 4.6 to 6.4, 4.8 to 6.2, or 5.0 to 6.0.

In one embodiment, the dispersant is a superplasticizer. The term “superplasticizer” as used herein refers to one or more materials that can provide improved flow characteristics and performance efficiency to mixtures, such as curable compounds, including cementious compositions, mortars and mortar tiles, grouts, screeds, pigment slurries, plasters, overprint varnishes, coatings, and adhesives. As used herein, the term “superplasticizer” refers to both plasticizer and superplasticizer chemicals. In one embodiment the superplasticizer is selected from the group consisting of a polycarboxylate ether, a sulfo-modified melamine-formaldehyde condensate, a melamine formaldehyde condensate, a sulfonated melamine-formaldehyde condensate, a lignin salt, a naphthalene sulfonate, a polycarboxylated acrylic, a polycarboxylated ether, a cocomide derivative, and mixtures thereof.

In one embodiment the superplasticizer is a sulfo-modified melamine-formaldehyde condensate, for instance, a melamine formaldehyde sulfonate (MFS) or a sulfonated melamine-formaldehyde condensate. In one embodiment, from the viewpoint of workability, the dispersant is preferably a polycarboxylate ether, and in a further embodiment the dispersant may comprise pendant polyethylene oxide groups.

### Superplasticizer; Polycarboxylate Ether Copolymer

In one embodiment, the superplasticizer is a polycarboxylate ether copolymer including constituent unit (4) represented by the following formula (4) and constituent unit (5) represented by the following formula (5):

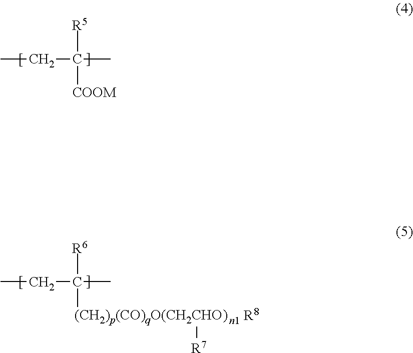

where R⁵ and R⁷ are the same or different and each represents a hydrogen atom or a methyl group, R⁶ and R⁸ are the same or different and each represents a hydrogen atom or an alkyl group with 1 or more and 3 or less carbons, M represents a hydrogen atom, an alkali metal, an alkaline earth metal, ammonium or an organic ammonium, p represents a number of 0 or more and 2 or less, q represents a number of 0 or 1, and n1 represents an average number of added moles and represents a number of 5 or more and 150 or less

For constituent unit (4) represented by the formula (4), R⁵ is a hydrogen atom or a methyl group, and preferably includes a methyl group. M is a hydrogen atom, an alkali metal, an alkaline earth metal, ammonium, or an organic ammonium, and preferably an alkali metal or an alkaline earth metal. Constituent unit (4) may be two or more. Examples of a monomer that may be constituent unit (4) include a monomer selected from acrylic acid, methacrylic acid, and salts thereof. In the viewpoint of storage stability and defoamability, methacrylic acid and its salt are preferred.

For constituent unit (5) represented by the formula (5), R⁶ and R⁸ are the same or different and each represents a hydrogen atom or an alkyl group with 1 or more and 3 or less carbons from the viewpoint of reactivity, and each represents preferably an alkyl group with 1 carbon, i.e., a methyl group from the viewpoint of storage stability. Further, R⁷ is a hydrogen atom or a methyl group and preferably a hydrogen atom from the viewpoint of storage stability. Constituent unit (5) may be two or more. p represents a number of 0 or more and 2 or less, and is preferably 0 or more and 1 or less and more preferably 0 from the viewpoint of storage stability. q represents a number of 0 or 1, and is preferably 1 from the viewpoint of storage stability.

n1 is an average number of added moles, and represents a number of 5 or more and 150 or less. From the viewpoint of storage stability, n1 is preferably 15 or more, and n is preferably 140 or less, more preferably 130 or less and further preferably 120 or less.

In another aspect of the present invention, from the viewpoint of storage stability and cement dispersibility, n1 is preferably 15 or more, and n is preferably 140 or less, more preferably 130 or less, further preferably 120 or less, further preferably 100 or less, further preferably 80 or less, further preferably 70 or less, further preferably 60 or less, further preferably 50 or less, further preferably 40 or less, and further preferably 30 or less.

In another aspect of the present invention, from the viewpoint of storage stability and strength of hydraulic composition, the range of n1 may be 80 or more, and 150 or less, preferably 140 or less, more preferably 130 or less and more preferably 120 or less.

In one embodiment, the constituent unit (5) may be a monomer selected from the group consisting of methoxy polyethylene glycol monomethacrylate, polyoxyethylene methallyl ether, polyoxyethylene isoprenyl ether, and polyoxyethylene vinyl ether. In the viewpoint of storage stability and defoamability, methoxy polyethylene glycol monomethacrylate is preferred.

In one embodiment, the polycarboxylate ether copolymer includes constituent unit (6) represented by the following formula (6) from the viewpoint of fluidity retaining performance:

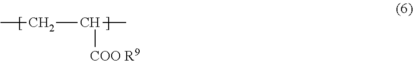

wherein R⁹ represents a hydrocarbon group with 1 or more and 4 or less carbons which may include heteroatoms.

R⁹ in the formula (6) represents a hydrocarbon group with 1 or more and 4 or less carbons which may include heteroatoms, and is preferably a hydroxyethyl group or a methyl group.

Constituent unit (6) is preferably a constituent unit with a compound selected from alkyl (with 1 or more and 4 or less carbons) acrylates and alkyl (with 1 or more and 4 or less carbons) methacrylates as a monomer.

The polycarboxylate ether copolymer is preferably a copolymer including constituent unit (4), constituent unit (5), and optionally constituent unit (6). In one embodiment, from the viewpoint of cement dispersibility, a proportion of constituent unit (4) is 45 mol % or more and 95 mol % or less, a proportion of constituent unit (5) is 5 mol % or more and 30 mol % or less, and a proportion of constituent unit (6) is 0 mol % or more and 35 mol % or less relative to the total moles of constituent units (4) to (6).

In one embodiment, from the viewpoint of cement dispersibility and storage stability, a proportion of constituent units (4) in the copolymer that are monomers is 55 mol % or more and preferably 65 mol % or more, more preferably 70 mol % or more, and 90 mol % or less, more preferably 85 mol % or less, and more preferably 80 mol % or less relative to the total moles of constituent units (4) to (6).

In one embodiment, a proportion of constituent units (5) in the copolymer that are monomers is preferably 10 mol % or more and more preferably 15 mol % or more, and 25 mol % or less and more preferably 20 mol % or less relative to the total moles of constituent units (4) to (6).

In one embodiment, a proportion of constituent units (6) in the copolymer that are monomers is preferably 5 mol % or more and more preferably 10 mol % or more, and 25 mol % or less and preferably 15 mol % or less relative to the total moles of constituent units (4) to (6).

In one embodiment, from the viewpoint of cement dispersibility, a molar ratio of constituent unit (4) to constituent unit (5) in the polycarboxylate ether copolymer, constituent unit (4)/constituent unit (5), is preferably 1 or more and more preferably 3 or more, and preferably 20 or less and more preferably 10 or less.

In one embodiment, a proportion of the total moles of constituent units (4) and (5) relative to all the constituent units of the polycarboxylate ether copolymer is preferably 80 mol % or more and more preferably 90 mol % or more, and preferably 100 mol % or less, or preferably 100 mol %.

In one embodiment, a proportion of the total moles of constituent units (4), (5), and (6) relative to all the constituent units of the polycarboxylate ether copolymer is preferably 80 mol % or more and more preferably 90 mol % or more, and preferably 100 mol % or less, or preferably 100 mol %.

In one embodiment, a weight average molecular weight (Mw) of the polycarboxylate ether copolymer is preferably 20,000 or more, more preferably 25,000 or more, further preferably 30,000 or more and furthermore preferably 35,000 or more, and preferably 70,000 or less, more preferably 60,000 or less and further preferably 55,000 or less from the viewpoint of cement dispersibility. This weight average molecular weight is measured by gel permeation chromatography (GPC) under the following conditions:

### GPC Conditions

Instrument: GPC (HLC-8320GPC) manufactured by Tosoh Corporation
Column: G4000PWXL+G2500PWXL (manufactured by Tosoh Corporation)
Eluent: 0.2 M phosphate buffer/CH₃CN=9/1
Flow rate: 1.0 mL/min
Column temperature: 40 °C.
Detection: RI
Sample size: 0.2 mg/mL
Standard substance: expressed in terms of polyethylene glycol (monodisperse polyethylene glycol: molecular weight 87,500, 250,000, 145,000, 46,000, 24,000).

In one embodiment, the admixture when formed is a clear homogeneous solution that does not develop phase separation and does not develop haze or cloudiness for an extended period. In other words, the solution does not develop turbidity or a noticeable level of precipitated solids, for instance, the turbidity measured in Nephelometric Units (NTU) by USEPA Method 180.1 may be 100 or less, 80 or less, 60 or less, 50 or less, or 40 or less, where a lower NTU refers to lower turbidity and greater transparency.

In one embodiment, the admixture may not separate or develop haze or cloudiness for at least 7 days, at least 10 days, at least 14 days, at least 15 days, at least 20 days, at least 25 days, at least 30 days, at least 35 days, or at least 40 days. In a further embodiment, the admixture may not separate or develop haze or cloudiness for those time periods even when kept at a temperature of at least 20 °C, at least 30 °C, at least 35 °C, at least 40 °C, at least 50 °C, at least 55 °C, and/or less than 60 °C, or less than 50 °C.

According to a third aspect, the present disclosure provides a cement mixture which comprises a particulate cementitious component, the admixture of the second aspect of the disclosure, and water. From the viewpoint of workability, the solid content of the admixture is present in the cement mixture at preferably in a range of 0.05 to 1 wt %, 0.08 to 0.8 wt %, 0.1 to 0.5 wt %, 0.2 to 0.4 wt % by weight of cement.

In one embodiment, the cement mixture has a W/C ratio (water/cement mass ratio) of 0.37 to 0.50, 0.38 to 0.48, 0.39 to 0.46, 0.40 to 0.45, or 0.42 to 0.44.

In one embodiment, the cement mixture further comprises 45 to 60 wt %, 48 to 58 wt %, 50 to 57 wt %, 52 to 56 wt %, or about 55 wt % sand relative to a total weight of the cement mixture, or the cement mixture further comprises the sand at a concentration of 140 to 180 wt %, 150 to 175 wt %, or 160 to 170 wt % by weight of cement.

In one embodiment, the cement mixture has an 80% or greater reduction in air voids when compared with a substantially similar cement mixture that does not comprise the defoamer. For instance, the reduction in air voids may be 85% or greater, 90% or greater, 95% or greater, 97% or greater, or 98% or greater. In one embodiment the cement mixture may have a 100% reduction in air voids, meaning that air voids are not detected.

In one embodiment, air voids as measured in the cement mixture by ASTM D 3203-94 may be present at a concentration of 0.10% or less, 0.08% or less, 0.06% or less, 0.05% or less, 0.04% or less, or 0.03% or less.

According to another aspect, the present disclosure relates to a method of forming an admixture, the method comprising mixing an alkali aqueous solution, suspension, or slurry, and a defoamer described herein.

According to another aspect, the present disclosure relates to method of forming a cement mixture, the method comprising mixing a particulate cementitious component, the admixture of the second aspect, and water.

According to another aspect, the present disclosure relates to a method of forming a cement mixture, the method comprising mixing a particulate cementitious component, the defoamer of the first aspect, a dispersant, and water.

According to another aspect, the present disclosure relates to method for reducing air voids in a cement mixture, the method comprising: mixing the admixture of the second aspect with a cement mixture having air voids, wherein an amount of air voids as measured by ASTM D 3203-94 is reduced by 80% or greater, 85% or greater, 90% or greater, 95% or greater, or 97% or greater relative to a substantially similar cement mixture mixed with a substantially similar admixture which does not comprise the defoamer of the first aspect.

According to another aspect, the present disclosure relates to a method for reducing air voids in a cement mixture, the method comprising mixing the defoamer of the first aspect and a dispersant with a cement mixture.

According to another aspect, the present disclosure relates to a use for a defoamer comprising a polyalkoxylated alkyl polyamine having a structure represented by Formula (2) and salts thereof

R¹—N(CH₂—CH₂—CH₂—N(R³)(R⁴))₂ (2),

where R¹ is a branched or unbranched hydrocarbon chain of 1 to 20 carbons in length, and R², R³, and R⁴ each independently represent H, an alkylene oxide, or a polyalkylene oxide.

According to a further aspect, the present disclosure relates to a use of the defoamer for an alkali aqueous solution, suspension, or slurry.

According to a further aspect, the present disclosure relates to a use of the defoamer for a hydraulic composition.

In other embodiments the defoamer may be combined with additional components. The resulting compositions may be incorporated into cement, mortar, concrete compositions, overprint varnishes, plastic coatings, clear coats, inks, dyes, or other suitable applications. Examples of suitable additional components include wetting agents, flow and leveling agents, shrinkage reducing agents, naphthalene sulfonates, polystyrene sulfonates, phosphates, phosphonates, cross-linked homo- or co-polymers of acrylic acid and salts thereof, calcium salts of organic acids, preferably having 1 to about 4 carbon atoms, alkanoic acids and salts thereof, aluminum sulfate, metallic aluminum, bentonite, montmorillonite, sepiolite, polyamide fibers, polypropylene fibers, polyvinyl alcohol, and homo-, co-, or terpolymers based on vinyl acetate, maleic ester, ethylene, styrene, butadiene, vinyl versatate, and acrylic monomers, and redispersible dispersion powders such as polyvinyl acetate, polyethylene-polyvinyl acetate, polyvinyl alcohol, and homo-, co-, or terpolymers based on vinyl acetate, maleic esters, ethylene, styrene, butadiene, vinyl versatate, and acrylic monomers. Other suitable components include short and long fibers such as steel, glass, carbon, polyolefins, polyesters, and polyamide fibers. Rheology modifiers (cellulose containing and polysaccharide additives, including starch, biopolymers such as xanthan gum) and alkali swellable acrylic associative thickeners (containing cellulose and/or meth (acrylic) functionalities) may also be used, as well as fine and/or coarse aggregates and/or fillers such as sands or clays. Other inorganic cement components such as gypsum, blast furnace slag, fly ash, aluminum sulfate, metallic aluminum, bentonite, montmorillonite, and sepiolite may be included, as well as dyes, pigments, and micronized coloring agents. Other functional additives include set accelerators and/or set retarders, water repellents, hydrophobizing agents, corrosion inhibitors, flame retardants, biocides, and fungicides.

The following are exemplary Embodiments of the present disclosure:

Embodiment (1): A defoamer for reduction of air entrainment in alkali aqueous solution, suspension, or slurry, comprising a polyalkoxylated alkyl polyamine having a structure represented by Formula (1) or (2), and salts thereof

R¹—(N(R²)—CH₂—CH₂—CH₂)ₙ—N—(R³)(R⁴) (1),

R¹—N(CH₂—CH₂—CH₂—N(R³)(R⁴))₂ (2),
wherein R¹ is a branched or unbranched hydrocarbon chain of 1 to 20 carbons in length, R², R³, and R⁴ each independently represent at least one or more of H, an alkylene oxide, or a polyalkylene oxide, and n is 1 to 50.

Embodiment (2): A defoamer for reduction of air entrainment, comprising a polyalkoxylated alkyl diamine having a structure represented by Formula (3) and salts thereof

R¹—N(R²)—CH₂—CH₂—CH₂—N—(R³)₂ (3),
where R¹ is a branched or unbranched hydrocarbon chain of 1 to 20 carbons in length, and R² and R³ each independently represent H, an alkylene oxide, or a polyalkylene oxide.

Embodiment (3): The defoamer of Embodiment (1) or (2), where the alkylene oxide is propylene oxide or ethylene oxide.

Embodiment (4): The defoamer of any one of Embodiments (1) to (3), where the polyalkylene oxide comprises repeating groups of propylene oxide and/or ethylene oxide.

Embodiment (5): The defoamer of any one of Embodiments (1) to (4), where the alkylene oxide is propylene oxide, and the polyalkylene oxide is polypropylene oxide.

Embodiment (6): The defoamer of any one of Embodiments (1) to (5), where R¹ is a branched or unbranched hydrocarbon chain of 12 to 18 carbons in length.

Embodiment (7): The defoamer of any one of Embodiments (1) to (6), where a combined weight percentage of propylene oxide and polypropylene oxide is in a range of 45 to 75 wt %, relative to the polyalkoxylated alkyl polyamine.

Embodiment (8): An admixture, comprising the defoamer of any one of Embodiments (1) to (7) and an alkali aqueous solution, suspension, or slurry.

Embodiment (9): An admixture for reduction of air entrainment, comprising: a dispersant, the defoamer of any one of Embodiments (1) to (7), and water. The dispersant and the defoamer are present at a combined concentration in a range of 25 to 35 wt % relative to the total weight of the admixture, and the defoamer is present at a concentration of 0.1 to 20 wt % relative to the weight of the dispersant.

Embodiment (10): The admixture of Embodiment (9), where the defoamer is present at a concentration of 4 to 15 wt % relative to a total weight of the dispersant.

Embodiment (11): The admixture of Embodiment (9) or (10), which has a pH in a range of 4.5 to 6.5.

Embodiment (12). The admixture of any one of Embodiments (9) to (11), where the dispersant is a superplasticizer selected from the group consisting of a polycarboxylate ether, a sulfo-modified melamine-formaldehyde condensate, a melamine formaldehyde condensate, a sulfonated melamine-formaldehyde condensate, a lignin salt, a naphthalene sulfonate, a polycarboxylated acrylic, a polycarboxylated ether, a carboxylic acid salt, casein, a cocomide derivative, and mixtures thereof.

Embodiment (13). The admixture of any one of Embodiments (9) to (12) where the dispersant is at least one selected from the group consisting of a polycarboxylate ether, an ester-type dispersant, an ether-type dispersant, and a naphthalene type dispersant.

Embodiment (14): The admixture of any one of Embodiments (9) to (13) where the dispersant is a polycarboxylate ether comprising pendant polyethylene oxide groups.

Embodiment (15): A cement mixture, comprising a particulate cementitious component, the admixture of any one of Embodiments (9) to (14), and water, where a solid content of the admixture is present in the cement mixture at a concentration in a range of 0.05 to 1 wt % by weight of cement.

Embodiment (16): The cement mixture of Embodiment (15), where the solid content of the admixture is present in the cement mixture at a concentration in a range of 0.1 to 0.5 wt % by weight of cement.

Embodiment (17): The cement mixture of Embodiment (15) or (16), which has a W/C ratio of 0.37 to 0.50.

Embodiment (18): The cement mixture of any one of Embodiments (15) to (17), further comprising 45-60 wt % sand relative to a total weight of the cement mixture.

Embodiment (19): A method of forming an admixture, the method comprising mixing an alkali aqueous solution, suspension, or slurry, and the defoamer of any one of Embodiments (1) to (7).

Embodiment (20): A method of forming a cement mixture, the method comprising mixing a particulate cementitious component, the defoamer of any one of Embodiments (1) to (7), a dispersant, and water. The admixture is present in the cement mixture at a solid content concentration in a range of 0.05 to 1 wt % by weight of cement.

Embodiment (21): A method of forming a cement mixture, the method comprising mixing a particulate cementitious component, the admixture of any one of Embodiments (9) to (14), and water. The admixture is present in the cement mixture at a solid content concentration in a range of 0.05 to 1 wt % by weight of cement.

### Embodiment (22)

A method for reducing air voids in a cement mixture, the method comprising: mixing the defoamer of claim any one of Embodiments (1) to (7), and a dispersant with a cement mixture.

Embodiment (23): Use for a defoamer of a composition comprising a polyalkoxylated alkyl polyamine having a structure represented by Formula (1) or (2), and salts thereof

R¹—(N(R²)—CH₂—CH₂—CH₂)ₙ—N—(R³)(R⁴) (1),

R¹—N(CH₂—CH₂—CH₂—N(R³)(R⁴))₂ (2),
where R¹ is a branched or unbranched hydrocarbon chain of 1 to 20 carbons in length, R², R³, and R⁴ each independently represent H, an alkylene oxide, or a polyalkylene oxide, and n is 1 to 50.

Embodiment (24): Use for the defoamer of Embodiment (23) for an alkali aqueous solution, suspension, or slurry.

Embodiment (25): Use for the defoamer of Embodiment (23) for a hydraulic composition.

The examples below are intended to further illustrate protocols for preparing the defoamer and admixture, and uses thereof, and are not intended to limit the scope of the claims.

### EXAMPLES

Aqueous dispersant and defoamer mixtures were prepared with varying defoamer loadings while keeping the overall actives content constant at 30% by weight. Polymers M-1, M-2, and M-3 are Ester-type polycarboxylate dispersant superplasticizers and are commercially available from Kao Specialties Americas, High Point, N.C. Specifically, Polymer M-1 was composed of a 40% solids aqueous copolymer of sodium methacrylate and methoxy polyoxyethylene (100) methacrylate (80/20 mol %), Mw: 50,000. Polymer M-2 was composed of a 50% solids aqueous copolymer of sodium methacrylate and methoxy polyoxyethylene (20) methacrylate (70/30 mol %), Mw: 50,000. Polymer M-3 was composed of a 40% solids aqueous copolymer of sodium methacrylate and methoxy polyoxyethylene (100) methacrylate (90/10 mol %), Mw: 40,000. Polymer M-4 is a commercially available naphthalenesulonic acid-formaldehyde condensate superplasticizer (for example, MIGHTY 150 from Kao Corporation, Tokyo, JP). Polymer M-5 is an ether-type polycarboxylate dispersant was composed of a 50% solids aqueous copolymer of sodium acrylate and polyoxyethylene (50) methallyl ether (85/15 mol %), Mw: 40,000.

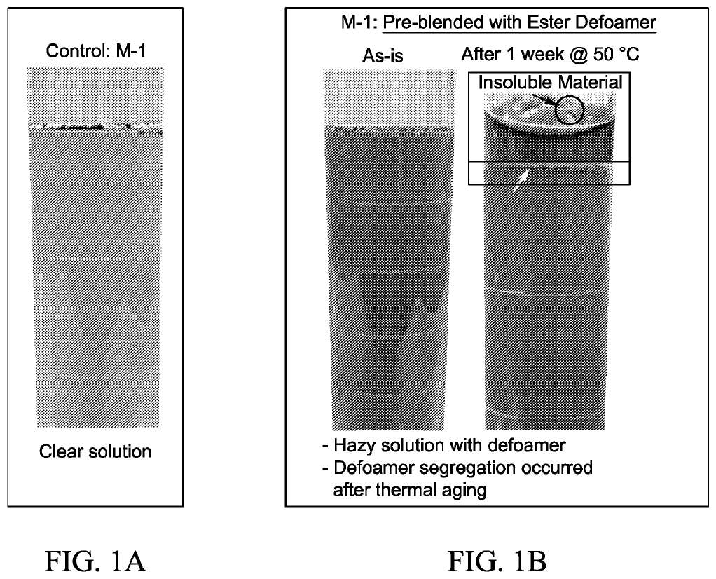

Defoamers widely accepted in this industry with different functionalities, such as esters, silicones, and nonionic alkoxylates, all separated into two phases after 2-3 days storage at 50 °C as shown in Table 4 and FIG. 1. Amine-based defoamers disclosed in prior art, such as ethylene diamine block polyoxyethers and alkyl ether amine, provided stable solutions while a tertiary alkyl amine was unstable. Aqueous dispersant solutions including the inventive amine defoamers were all comparatively stable at 50 °C for an extended period as shown in Tables 4 and 5.

TABLE 1
Defoamer compositions

| Defoamer | | Propylene Oxide |
|---|---|---|
| Sample | Diamine(Triamine) | Wt. % |
| S1 | N-(Tallowalkyl)trimethylenediamine | 51 |
| S2 | N-(Tallowalkyl)trimethylenediamine | 61 |
| S3 | N-(Tallowalkyl)trimethylenediamine | 72 |
| S4 | N-(Oleyl)trimethylenediamine | 50 |
| S5 | N-(Cocoalkyl)trimethylenediamine | 56 |
| S6 | N-(Tallowalkyl)dipropylene triamine | 55 |

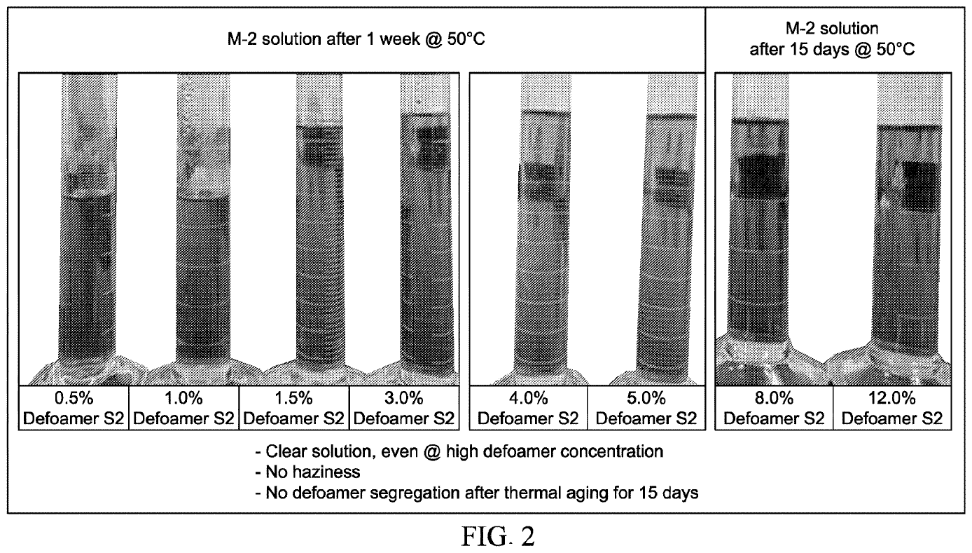

The homogeneous solution can be observed in FIG. 2. One typical limitation for aqueous defoamer and polycarboxylate blends is that the hydrophobic defoamer can only be formulated at limited concentrations to avoid separation. The inventive Defoamer S2 highlights that this defoamer can be incorporated at, without limitation, 12% of the dispersant formulation (loading based on active PCE). At both low and high loadings of the inventive defoamer, the blend with the dispersant produces clear and stable solutions.

The defoaming property of various polyalkoxylated alkyl polyamine additives was evaluated in a standard mortar test for air-voids content. Ordinary Portland cement Type-I was used at a sand/cement/water ratio of 2.2/1.3/0.5. All tests were carried out in the presence of a superplasticizer dispersant. The dose of the dispersant was 0.10% (active) by weight of cement and the ratio of defoamer to dispersant was 0.10% active by weight. The air-voids content was measured in accordance with ASTM D 3203-94 using a 400 ML Measure of 3″ internal diameter according to ASTM C-185.

Different polyalkoxylated alkyl polyamines were compared with defoamers widely used in the industry in comparative examples as shown in Table 2 with ester-type polycarboxylate dispersant M-1. The defoaming capability of the inventive Defoamer S2 was compared with the ether-type polycarboxylate dispersant composed of a 50% solids aqueous copolymer of sodium acrylate and polyoxyethylene (50) methallyl ether (85/15 mol %) as shown in Table 3.

TABLE 2
Comparative effect of defoamers on mortar air-voids control
with ester-type polycarboxylate dispersant M-1.

| | Defoamer/(active) | Air Voids |
|---|---|---|
| Sample reference | Dispersant (%) | (%) |
| Control (No Defoamer) | 0 | 5.22 |
| Ester Defoamer | 0.1 | 1.21 |
| | 0.5 | 0.18 |
| Silicone Defoamer | 0.1 | 1.42 |
| Ethylene Diamine Block POE Defoamer | 0.1 | 2.36 |
| | 0.5 | 2.35 |
| Tertiary Alkyl Amine Defoamer | 0.1 | 2.08 |
| | 0.5 | 1.38 |
| Defoamer S1 | 0.1 | −1.12 |
| | 0.5 | −1.44 |
| Defoamer S2 | 0.1 | −1.40 |
| | 0.5 | −1.85 |
| Defoamer S3 | 0.1 | −1.32 |
| | 0.5 | −1.99 |
| Defoamer S4 | 0.1 | −1.04 |
| | 0.5 | −1.16 |
| Defoamer S5 | 0.1 | −0.83 |
| | 0.5 | −1.24 |
| Defoamer S6 | 0.1 | −0.70 |
| | 0.5 | −1.68 |

TABLE 3
Effect of Defoamer S2 on mortar air-voids control
with ether-type polycarboxylate dispersant.

| | Defoamer/(active) | Air Voids |
|---|---|---|
| Sample reference | Dispersant (%) | (%) |
| Control (No Defoamer) | 0 | 7.56 |
| Defoamer S2 | 0.1 | 2.87 |
| | 0.5 | 0.74 |

TABLE 4
Comparative defoamer/PCE solution stability with
ester-type polycarboxylate dispersant M-2.

| | Defoamer | | Stability |
|---|---|---|---|
| | Loading | PCE/Defoamer | in Days @ |
| Sample reference | (wt %) | Blend Appearance | 50 °C |
| Ester Defoamer | 0.5 | Cloudy | 3 |
| Silicone Defoamer | 0.5 | Cloudy | 2 |
| Nonionic Alkoxylate Defoamer | 0.5 | Clear | 3 |
| Ethylene Diamine Block POE | 0.5 | Clear | 10+ |
| Defoamer | | | |
| Alkyl Ether Amine Defoamer | 0.5 | Cloudy | 5+ |
| Tertiary Alkyl Amine Defoamer | 0.5 | Cloudy | 0 |
| S1 | 0.5 | Cloudy | 0 |
| S2 | 0.5 | Clear | 250+ |
| | 1.5 | Clear | 250+ |
| | 5 | Clear | 250+ |
| | 11 | Clear | 300+ |
| S3 | 0.5 | Clear | 3 |
| S4 | 5 | Clear | 40+ |
| S5 | 5 | Cloudy | 3 |
| S6 | 5 | Clear | 40+ |

TABLE 5
Comparative defoamer/dispersant solution stability.

| | | | Defoamer | | Stability |
|---|---|---|---|---|---|
| Dispersant | Dispersant | | Loading | PCE/Defoamer | in Days @ |
| Type | Reference | Sample reference | (wt %) | Blend Appearance | 50 °C |
| Ester-Type | MIGHTY 21ES | Ester Defoamer | 0.5 | Cloudy | 3 |
| | | S2 | 0.5 | Clear | 10+ |
| | | | 5 | Clear | 250+ |
| | MIGHTY 21EG | Ester Defoamer | 0.5 | Cloudy | 3 |
| | | S2 | 0.5 | Clear | 10+ |
| | | | 5 | Clear | 50+ |
| Naphthalene | MIGHTY 150 | Ester Defoamer | 0.5 | Cloudy | 3 |
| Derivative | | S2 | 0.5 | Clear | 10+ |
| | | | 5 | Clear | 50+ |
| Ether-Type | Sodium acrylate- | Ester Defoamer | 5 | Cloudy | 2 |
| | POE(50) | S2 | 0.5 | Clear | 40+ |
| | methallyl ether | | 5 | Clear | 40+ |
| | copolymer | | | | |

Compared to the control mix without defoamer, the lower air-voids with the inventive additives, object of this invention, clearly indicates that polyalkoxylated alkyl polyamines Defoamers S1-S6 performed effectively as foam control agents, achieving superior air-voids reduction in the mortar mix than the comparative industry standard defoamers. The results indicate that the defoamer functionality described in this invention outperforms conventional and amine defoamers known in the art.

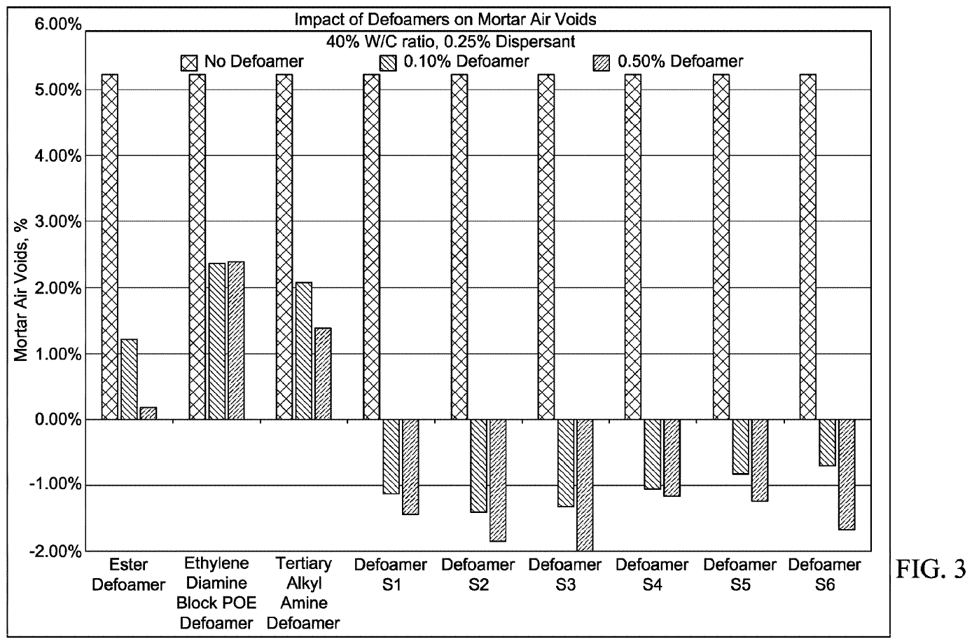

The mortar test procedure described in the above example was repeated, except that the ratio of defoamer to active dispersant was 0.10% or 0.50% by weight. Data in Table 2 shows that the inventive Defoamers S1-S6 all show significant air-voids reduction, below the threshold of the control example (ester defoamer). Aid-voids reduction is further improved by increasing the defoamer concentration to 0.50% by weight. All the three inventive examples outperformed the comparative industry standards and amine-based defoamers used in this example. The results are also represented graphically in FIG. 3.

### Preparation of Defoamer/PCE Solutions at Various Defoamer Loadings

Aqueous mixtures of a polycarboxylate dispersant and the inventive polyalkoxylated alkyl polyamines were prepared to yield solutions with a solids content of 30% total weight. The two components were blended for 30 minutes at room temperature with a final pH between 5-6. The resulting solution was clear and showed no separation or defoamer segregation after extended storage at room temperature and 50 °C over a period of one month (FIG. 2). The polymeric dispersant comprised a backbone having polycarboxylate groups and pendant polyethylene oxide groups. The alkyl polyamines are derived from N-(tallowalkyl)trimethylenediamine, N-(oleyl)trimethylenediamine, N-(coco) trimethylenediamine, or N-(tallowalkyl)dipropylene triamine or with different degrees of polypropoxylation, indicated by the weight % of propylene oxide of the total molecular weight, which is provided in Table 1.

1. A method of forming an admixture, the method comprising:
mixing an alkali aqueous solution, suspension, or slurry, and a defoamer,
wherein the defoamer comprises a polyalkoxylated alkyl polyamine having a structure represented by Formula (1) or (2), and salts thereof
R¹—(N(R²)—CH₂—CH₂—CH₂)ₙ—N—(R³)(R⁴) (1),
R¹—N(CH₂—CH₂—CH₂—N(R³)(R⁴))₂ (2),
wherein:
R¹ is a branched or unbranched hydrocarbon chain of 1 to 20 carbons in length,
R², R³, and R⁴ each independently represents at least one or more of H, an alkylene oxide, or a polyalkylene oxide,
n is 1 to 50, and
the alkylene oxide is propylene oxide or ethylene oxide.

2. A method of forming an admixture, the method comprising:
mixing an alkali aqueous solution, suspension, or slurry, and a defoamer,
wherein the defoamer comprises a polyalkoxylated alkyl diamine having a structure represented by Formula (3) and salts thereof
R¹—N(R²)—CH₂—CH₂—CH₂—N—(R³)₂ (3),
wherein:
R¹ is a branched or unbranched hydrocarbon chain of 1 to 20 carbons in length,
R² and R³ each independently represents an alkylene oxide or a polyalkylene oxide, and
the alkylene oxide is propylene oxide or ethylene oxide.

3. (canceled)

4. The method of forming an admixture of claim 1, wherein the alkylene oxide is propylene oxide, and the polyalkylene oxide is polypropylene oxide.

5. The method of forming an admixture of claim 1, wherein R¹ is a branched or unbranched hydrocarbon chain of 12 to 18 carbons in length.

6. The method of forming and admixture of claim 4, wherein a combined weight percentage of propylene oxide and polypropylene oxide is in a range of 45 to 75 wt %, relative to the polyalkoxylated alkyl polyamine.

7. (canceled)

8. An admixture for reduction of air entrainment, comprising:
a dispersant;
a defoamer; and
water,
wherein the dispersant and the defoamer are present at a combined concentration in a range of 25 to 35 wt % relative to the total weight of the admixture,
wherein the defoamer comprises a polyalkoxylated alkyl polyamine having a structure represented by Formula (1) or (2), and salts thereof
R¹—(N(R²)—CH₂—CH₂—CH₂)ₙ—N—(R³)(R⁴) (1),
R¹—N(CH₂—CH₂—CH₂—N(R³)(R⁴))₂ (2),
wherein:
R¹ is a branched or unbranched hydrocarbon chain of 1 to 20 carbons in length,
R², R³, and R⁴ each independently represents at least one or more of H, an alkylene oxide, or a polyalkylene oxide,
n is 1 to 50, and
the alkylene oxide is propylene oxide or ethylene oxide, and
wherein the defoamer is present at a concentration of 0.1 to 20 wt % relative to the weight of the dispersant.

9. The admixture of claim 8, wherein the defoamer is present at a concentration of 4 to 15 wt % relative to a total weight of the dispersant.

10. The admixture of claim 8, which has a pH in a range of 4.5 to 6.5.

11. The admixture of claim 8, wherein the dispersant is a superplasticizer selected from the group consisting of a polycarboxylate ether, a sulfo-modified melamine-formaldehyde condensate, a melamine formaldehyde condensate, a sulfonated melamine-formaldehyde condensate, a lignin salt, a naphthalene sulfonate, a polycarboxylated acrylic, a polycarboxylated ether, a carboxylic acid salt, casein, a cocomide derivative, and mixtures thereof.

12. The admixture of claim 8, wherein the dispersant is at least one selected from the group consisting of a polycarboxylate ether, an ester-type dispersant, an ether-type dispersant, and a naphthalene type dispersant.

13. The admixture of claim 8, wherein the dispersant is a polycarboxylate ether comprising pendant polyethylene oxide groups.

14. A cement mixture, comprising:
a particulate cementitious component;
the admixture of claim 8; and
water,
wherein a solid content of the admixture is present in the cement mixture at a concentration in a range of 0.05 to 1 wt % by weight of cement.

15. The cement mixture of claim 14, wherein the solid content of the admixture is present in the cement mixture at a concentration in a range of 0.1 to 0.5 wt % by weight of cement.

16. The cement mixture of claim 14, which has a W/C ratio of 0.37 to 0.50.

17. The cement mixture of claim 14, further comprising 45-60 wt % sand relative to a total weight of the cement mixture.

18. (canceled)

19. A method of forming a cement mixture, the method comprising:
mixing a particulate cementitious component,
the admixture of claim 8, and
water,
wherein the solid content of the admixture is present in the cement mixture at a concentration in a range of 0.05 to 1 wt % by weight of cement.

20-21. (canceled)

22. A method for reducing air voids in a cement mixture, the method comprising:
mixing a defoamer and a dispersant with a cement mixture,
wherein the defoamer comprises a polyalkoxylated alkyl polyamine having a structure represented by Formula (1) or (2), and salts thereof
R¹—(N(R²)—CH₂—CH₂—CH₂)ₙ—N—(R³)(R⁴) (1),
R¹—N(CH₂—CH₂—CH₂—N(R³)(R⁴))₂ (2),
wherein:
R¹ is a branched or unbranched hydrocarbon chain of 1 to 20 carbons in length,
R², R³, and R⁴ each independently represents at least one or more of H, an alkylene oxide, or a polyalkylene oxide,
n is 1 to 50, and
the alkylene oxide is propylene oxide or ethylene oxide.

23-25. (canceled)

26. The method of forming an admixture of claim 2, wherein the alkylene oxide is propylene oxide, and the polyalkylene oxide is polypropylene oxide.

27. The method of forming an admixture of claim 2, wherein R¹ is a branched or unbranched hydrocarbon chain of 12 to 18 carbons in length.

28. An admixture for reduction of air entrainment, comprising:
a dispersant;
a defoamer; and
water,
wherein the dispersant and the defoamer are present at a combined concentration in a range of 25 to 35 wt % relative to the total weight of the admixture,
wherein the defoamer comprises a polyalkoxylated alkyl diamine having a structure represented by Formula (3) and salts thereof
R¹—N(R²)—CH₂—CH₂—CH₂—N—(R³)₂ (3),
wherein:
R¹ is a branched or unbranched hydrocarbon chain of 1 to 20 carbons in length,
R² and R³ each independently represents an alkylene oxide or a polyalkylene oxide, and
the alkylene oxide is propylene oxide or ethylene oxide, and
wherein the defoamer is present at a concentration of 0.1 to 20 wt % relative to the weight of the dispersant.

29. A method for reducing air voids in a cement mixture, the method comprising:
mixing a defoamer and a dispersant with a cement mixture,
wherein the defoamer comprises a polyalkoxylated alkyl diamine having a structure represented by Formula (3) and salts thereof
R¹—N(R²)—CH₂—CH₂—CH₂—N—(R³)₂ (3),
wherein:
R¹ is a branched or unbranched hydrocarbon chain of 1 to 20 carbons in length,
R² and R³ each independently represents an alkylene oxide or a polyalkylene oxide, and
the alkylene oxide is propylene oxide or ethylene oxide.
